(19) United States
(12) Patent Application Publication
(10) Pub. No.: US 2020/0095872 A1
(43) Pub. Date: Mar. 26, 2020

(54) DAMPING DEVICE FOR TURBINE BLADE ASSEMBLY AND TURBINE BLADE ASSEMBLY HAVING THE SAME

(71) Applicant: DOOSAN HEAVY INDUSTRIES & CONSTRUCTION CO., LTD., Changwon-si (KR)

(72) Inventor: Ki Baek KIM, Changwon-si (KR)

(21) Appl. No.: 16/508,310

(22) Filed: Jul. 11, 2019

(30) Foreign Application Priority Data
Sep. 21, 2018 (KR) 10-2018-0114220

(51) Int. Cl. F01D 5/22; F01D 5/16

(52) U.S. Cl. CPC F01D 5/22; F05D 2260/96; F01D 5/16

(57) ABSTRACT

A damping device for a turbine blade assembly is provided. The damping device may include a damper slot formed by first and second slots being axially opposite to each other under respective platforms of adjacent first and second turbine blades of a plurality of turbine blades radially disposed along circumferential surfaces of turbine rotor disks, and a damper pin disposed in the damper slot, wherein the damper pin disposed in the damper slot partially protrudes out of an open inlet of the first slot such that a height of the damper pin protruding out of the open inlet of the first slot is smaller than a gap distance between the first and second turbine blades.

### CROSS REFERENCE TO RELATED APPLICATION

This application claims priority to Korean Patent Application No. 10-2018-0114220, filed on Sep. 21, 2018, the entire disclosure of which is incorporated herein by reference in its entirety.

### BACKGROUND

### 1. Field

Apparatuses and methods consistent with exemplary embodiments relate to a damping device for damping vibration of turbine blades with excellent sealing effects, an easy assembly feature, and wide compatibility between various types of components thereof, and a turbine blade assembly having the damping device.

### 2. Description of the Background Art

A turbine is a mechanical device that obtains a rotational force by an impact force or a reaction force using a flow of a compressible fluid such as steam or gas. The turbine may include a steam turbine using steam and a gas turbine using a high temperature combustion gas.

The gas turbine includes a compressor, a combustor, and a turbine. The compressor includes an air inlet for introducing air, and a plurality of compressor vanes and compressor blades, which are alternately arranged in a compressor casing. The air introduced from outside is compressed through the rotary compressor blades up to a target pressure.

The combustor supplies fuel to the compressed air compressed in the compressor and ignites a fuel-air mixture with a burner to produce a high temperature and high pressure combustion gas.

The turbine includes a plurality of turbine vanes and turbine blades disposed alternately in a turbine casing. Further, a rotor is arranged to pass through the center of the compressor, the combustor, the turbine, and an exhaust chamber.

Both ends of the rotor are rotatably supported by bearings. A plurality of disks are fixed to the rotor so that the respective blades are connected and a drive shaft, such as a generator, is connected to an end of the exhaust chamber.

Because the gas turbines have no reciprocating mechanism such as a piston in a 4-stroke engine, there are no mutual frictional parts like a piston-cylinder, thus the gas turbines have advantages in that consumption of lubricating oil is extremely small, an amplitude as a characteristic of a reciprocating machine is greatly reduced, and high speed operation is possible.

Although the gas turbine has less vibration than the 4-stroke engine, vibration may occur in the turbine blades during operation. For example, when a change in the combustion gas flow at a high temperature occurs, the change in the combustion gas flow may cause the turbine blades to vibrate. Therefore, it is required for the design of a gas turbine, in particular a turbine section, to avoid or minimize dynamic stresses caused by resonance, forced response or aero-elastic instabilities at the natural frequency of the turbine blades so as to control the high cycle fatigue of the turbine blades.

In order to improve the high cycle fatigue of the turbine blades, a damping device is provided in which a damper slot is formed under platforms of adjacent turbine blades and a damper pin is disposed in the damping slot so that vibration energy is absorbed by friction, thereby damping the vibration during operation. In general, the damper pin has a shape like a cylindrical or asymmetrical polygonal column.

However, because the damper slot is formed with a concave space formed between the adjacent turbine blades, there arises a problem of sealing due to an inflow of high-pressure combustion gas or an outflow of cooling air therethrough. In addition, when assembling a turbine blade to a turbine rotor disk with the damper pin inserted into one turbine blade side, the damper pin should not interfere with the assembly. Further, the damper slot is required to be able to accommodate various types of damper pins therein without a change in the design of the damper slot.

A damping device that meets these diverse needs has not yet been provided, so a newly designed damping device is needed.

### SUMMARY

Aspects of one or more exemplary embodiments provide a damping device for damping vibration of turbine blades with excellent sealing effects, an easy assembly feature, and wide compatibility between various types of components thereof, and a turbine blade assembly having the damping device.

Additional aspects will be set forth in part in the description which follows and, in part, will become apparent from the description, or may be learned by practice of the exemplary embodiments.

According to an aspect of an exemplary embodiment, there is provided a damping device for a turbine blade assembly including: a damper slot formed by first and second slots being axially opposite to each other under respective platforms of adjacent first and second turbine blades of a plurality of turbine blades radially disposed along circumferential surfaces of turbine rotor disks; and a damper pin disposed in the damper slot, wherein the damper pin disposed in the damper slot partially protrudes out of an open inlet of the first slot such that a height of the damper pin protruding out of the open inlet of the first slot is smaller than a gap distance between the first and second turbine blades.

The damper pin may be a cylindrical damper pin, and a diameter of the cylindrical damper pin is larger than a depth of the first slot.

When the damper slot is viewed in a section perpendicular to an axial direction of the damper slot, the diameter of the cylindrical damper pin may be smaller than a diameter of a circle inscribed in a receiving space of the damper slot.

The damper pin may be a polygonal damper pin, and when at least two sides of the polygonal damper pin are in close contact with an inside of the first slot, a height of the polygonal damper pin protruding out of the open inlet of the first slot is smaller than the gap distance between the first and second turbine blades.

When the damper slot is viewed in a section perpendicular to an axial direction, a maximum width of the polygonal damper pin may be larger than a diameter of a circle inscribed in a receiving space of the damper slot.

Each upper surfaces of the first slot and the second slot may form an inclined surface inclined toward a direction of centrifugal force.

A circular cross section of the cylindrical damper pin, perpendicular to a longitudinal direction of the cylindrical damper pin, may be divided into a first semicircular area and a second semicircular area based on the diameter as a reference line, and specific gravity of the first semicircular area is lower than that of the second semicircular area so that a center of gravity of the damper pin is eccentric to the second semicircular area.

The first semicircular area may include a low specific gravity region having a density lower than that of a material of the damper pin.

The low specific gravity region may be filled with a material having a lower density than the material of the damper pin or the low specific gravity region may be formed as a hollow portion.

The low specific gravity region may be formed closer to a circumferential surface of the damper pin in the first semicircular area.

According to an aspect of another exemplary embodiment, there is provided a turbine blade assembly including: a plurality of turbine rotor disks; a plurality of turbine blades each radially disposed along a circumferential surface of the turbine rotor disk; and a damper device including a damper slot formed by first and second slots being axially opposite to each other under respective platforms of adjacent first and second turbine blades of a plurality of turbine blades radially disposed along circumferential surfaces of turbine rotor disks, and a damper pin disposed in the damper slot, wherein the damper pin disposed in the damper slot partially protrudes out of an open inlet of the first slot such that a height of the damper pin protruding out of the open inlet of the first slot is smaller than a gap distance between the first and second turbine blades.

The damper slot of the damping device according to an exemplary embodiment is configured such that the space thereof is adapted to accommodate various types of damper pins while being effectively reduced in size, thereby improving the sealing effect with easy assembly.

In addition, the exemplary embodiment has an advantage in which when various types of damper pins including a cylindrical damper pin and a polygonal damper pin are applied, sufficient vibration energy dissipation effect can be obtained while suppressing the risk of jamming.

### BRIEF DESCRIPTION OF THE DRAWINGS

The above and other aspects will be more apparent from the following description of the exemplary embodiments with reference to the accompanying drawings, in which:

FIG. 1 is a cross-sectional view illustrating a schematic structure of a gas turbine according to an exemplary embodiment;

FIG. 2 is a perspective view illustrating a turbine blade;

FIG. 3 is a view illustrating a state in which a damper pin is installed in a damper slot formed between adjacent turbine blades;

FIG. 4 is a view illustrating a damping device according to an exemplary embodiment;

FIG. 5 is a view illustrating a damping device according to another exemplary embodiment;

FIG. 6 is a view illustrating a cylindrical damper pin according to an exemplary embodiment;

FIGS. 7A and 7B are sectional views of the cylindrical damper pin of FIG. 6 cut in a direction perpendicular to the longitudinal direction; and

FIGS. 8A, 8B, and 8C are views illustrating a state in which the cylindrical damper pin of FIG. 6 maintains a constant posture without rotating in a damper slot during operation of the gas turbine.

### DETAILED DESCRIPTION

Various modifications may be made to the embodiments of the disclosure, and there may be various types of embodiments. Thus, specific embodiments will be illustrated in drawings, and the embodiments will be described in detail in the description. However, it should be noted that the various embodiments are not for limiting the scope of the disclosure to a specific embodiment, but they should be interpreted to include all modifications, equivalents or alternatives of the embodiments included in the ideas and the technical scopes disclosed herein. Meanwhile, in case it is determined that in describing the embodiments, detailed explanation of related known technologies may unnecessarily confuse the gist of the disclosure, the detailed explanation will be omitted.

Terms used herein are for the purpose of describing particular embodiments only, and are not intended to limit the scope of the disclosure.

As used herein, the singular forms “a”, “an”, and “the” are intended to include the plural forms as well unless the context clearly indicates otherwise. Further, terms such as “comprising”, “including”, or have/has should be construed as designating that there are such features, numbers, regions, steps, operations, elements, parts, and/or a combination thereof in the specification, not to exclude the presence or possibility of adding one or more of other features, numbers, regions, steps, operations, elements, parts, and/or combinations thereof.

Further, terms such as “first,” “second,” and so on may be used to describe a variety of elements, but the elements should not be limited by these terms. The terms are used simply to distinguish one element from other elements. The use of such ordinal numbers should not be construed as limiting the meaning of the term. For example, the components associated with such an ordinal number should not be limited in the order of use, placement order, or the like. If necessary, each ordinal number may be used interchangeably.

Hereinafter, exemplary embodiments will be described in detail with reference to the accompanying drawings. In order to clearly illustrate the disclosure in the drawings, some of the elements that are not essential to the complete understanding of the disclosure may be omitted, and like reference numerals refer to like elements throughout the specification.

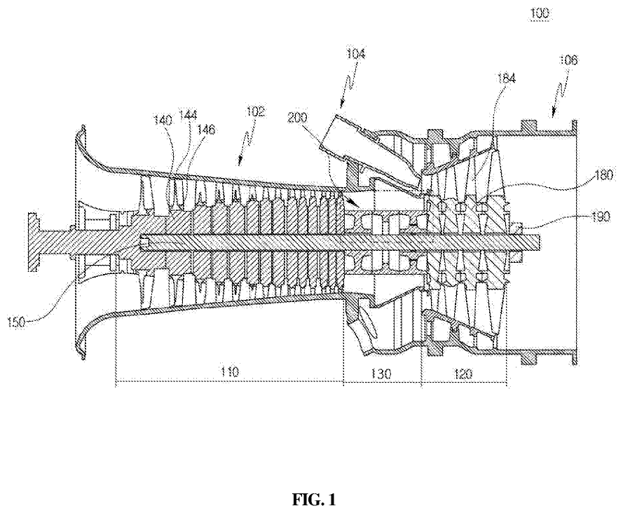

FIG. 1 is a cross-sectional view illustrating a schematic structure of a gas turbine according to an exemplary embodiment.

Referring to FIG. 1, a gas turbine 100 includes a housing 102 and a diffuser 106 which is disposed on a rear side of the housing 102 and through which a combustion gas passing through a turbine is discharged. A combustor 104 is disposed in front of the diffuser 106 to receive and burn compressed air.

Based on the direction of air flow, a compressor section 110 is located on an upstream side of the housing 102, and a turbine section 120 is located on a downstream side of the housing 102. A torque tube 130 is disposed as a torque transmission member between the compressor section 110 and the turbine section 120 to transmit the rotational torque generated in the turbine section 120 to the compressor section 110.

The compressor section 110 includes a plurality of compressor rotor disks 140, which are fastened by a tie rod 150 to prevent axial separation thereof.

For example, the compressor rotor disks 140 are axially arranged with the tie rod 150 passing through substantially central portion thereof. Here, neighboring compressor rotor disks 140 are disposed so that opposed surfaces thereof are pressed by the tie rod 150 and do not rotate relative to each other.

A plurality of compressor blades 144 are radially coupled to an outer circumferential surface of the compressor rotor disk 140. Each of the compressor blades 144 has a root portion 146 which is fastened to the compressor rotor disk 140.

A plurality of compressor vanes fixed to the housing 102 are respectively positioned between the compressor rotor disks 140. While the compressor rotor disks 140 rotate along with a rotation of the tie rod 150, the compressor vanes fixed to the housing 102 do not rotate. The compressor vanes guide the compressed air moved from front-stage compressor blades 144 to rear-stage compressor blades 144.

The fastening method of the root portion 146 may include a tangential type and an axial type. These may be chosen according to the required structure of the commercial gas turbine, and may have a generally known dovetail or fir-tree shape. In some cases, it is possible to fasten the compressor blades to the compressor rotor disk by using other fasteners such as keys or bolts in addition to the above-described fastening shape.

The tie rod 150 is arranged to pass through the center of the compressor rotor disks 140 such that one end thereof is fastened in the compressor rotor disk located on the most upstream side and the other end thereof is fastened in the torque tube 130.

It is understood that the shape of the tie rod 150 may not be limited to the example shown in FIG. 1 and may be changed or vary according to one or more other exemplary embodiments. For example, one tie rod may have a shape passing through a central portion of the compressor rotor disk, a plurality of tie rods may be arranged in a circumferential manner, or a combination thereof may be used.

Also, the compressor section 110 may include a vane serving as a guide element at the next position of the diffuser 106 in order to adjust a flow angle of a pressurized fluid entering a combustor inlet to a designed flow angle. The vane is referred to as a deswirler.

The combustor 104 mixes the introduced compressed air with fuel and combusts the air-fuel mixture to produce a high-temperature and high-pressure combustion gas. The combustor 104 increases the temperature of the combustion gas to a temperature at which the combustor and components of the turbine are able to be resistant to heat in an isobaric combustion process.

The combustor 104 consists of a plurality of combustors arranged in a form of a cell in a casing, and includes a burner having a fuel injection nozzle and the like, a combustor liner forming a combustion chamber, and a transition piece that is a connection between the combustor and the turbine.

The combustor liner provides a combustion space in which the fuel injected by the fuel nozzle is mixed with the compressed air supplied from the compressor and the fuel-air mixture is combusted. The combustor liner may include a flame canister providing the combustion space in which the fuel-air mixture is combusted, and a flow sleeve forming an annular space surrounding the flame canister. The fuel nozzle is coupled to a front end of the combustor liner, and an igniter is coupled to a side wall of the combustor liner.

The transition piece is connected to a rear end of the combustor liner to transmit the combustion gas to the turbine section. An outer wall of the transition piece is cooled by the compressed air supplied from the compressor to prevent thermal breakage due to the high temperature combustion gas.

To this end, the transition piece is provided with cooling holes through which compressed air is injected, and the compressed air cools the inside of the transition piece and flows towards the combustor liner.

The compressed air that has cooled the transition piece flows into an annular space of the combustor liner and is supplied as a cooling air to an outer wall of the combustor liner from an outside of a flow sleeve through cooling holes provided in the flow sleeve to collide with the cooling air.

The high-temperature and high-pressure combustion gas output from the combustor 104 is supplied to the turbine section 120. The supplied high-temperature and high-pressure combustion gas expands and provides a reaction force to rotate turbine blades of the turbine to cause a rotational torque, which is then transmitted to the compressor section 110 through the torque tube 130. Here, power exceeding the power required to drive the compressor section 110 is used to drive a generator or the like. The turbine section 120 is basically similar in structure to the compressor section 110. That is, the turbine section 120 may include a plurality of turbine rotor disks 180 similar to the compressor rotor disks 140 of the compressor section 110, and the turbine rotor disk 180 may include a plurality of turbine blades 184 disposed radially. For example, the turbine blade 184 may be coupled to the turbine rotor disk 180 in a dovetail coupling manner. Between the turbine blades 184 of the turbine rotor disk 180, a vane fixed to the housing 102 is provided to induce a flow direction of the combustion gas passing through the turbine blades 184.

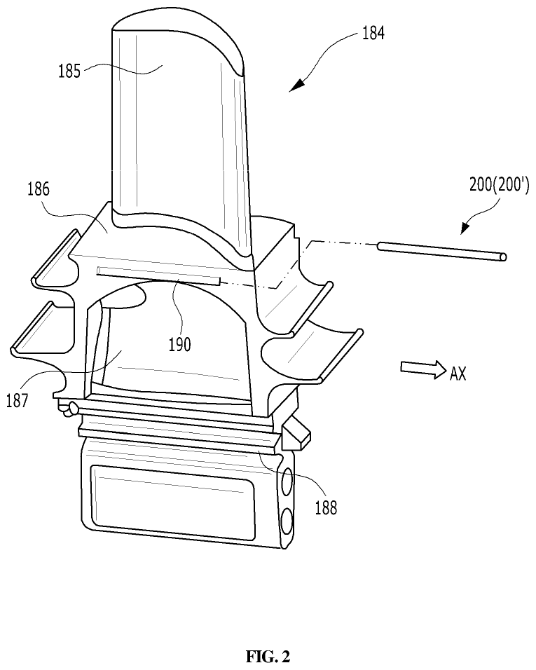

FIG. 2 is a view illustrating a first turbine blade 184 in a direction in which a first slot 190 is shown. The first turbine blade 184 has an elongated blade part (i.e., airfoil) 185 extending upwards from a platform 186 so that the blade part 185 receives a hydrodynamic force from the combustion gas. The first slot 190 is formed under the platform 186, and a shank 187 for providing a flow space for cooling air and a root part (i.e., dovetail part 188) connected to a circumferential surface of the turbine rotor disk 180 are provided in sequence under the platform 186.

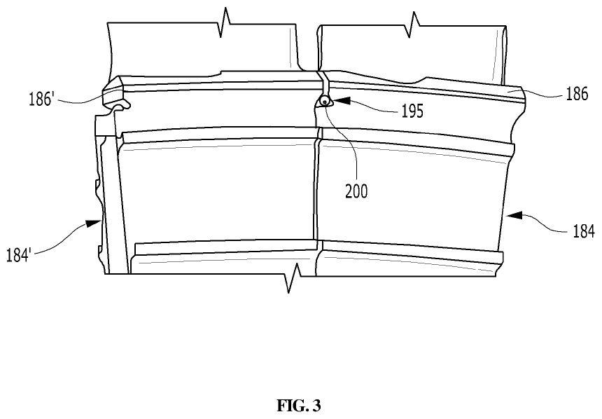

FIG. 3 is a view illustrating a state in which a damper pin is installed in a damper slot formed between adjacent turbine blades. Referring to FIGS. 2 and 3, the first slot 190 is formed under the platform 186 of the first turbine blade 184 along the axial direction AX of the gas turbine, and a second slot 190′ is formed under the platform 186 of a second turbine blade 184′ that is circumferentially adjacent to the first turbine blade 184 on the turbine rotor disk 180 such that the second slot 190′ faces the first slot 190. The first and second slots 190 and 190′ facing each other under respective platforms 186 of the adjacent first and second turbine blades 184 and 184′ are disposed in the axial direction AX to form a single integral damper slot 195 into which a damper pin 200 is inserted. The damper slot 195 and the damper pin 200 constitute a single damping device in which friction is caused between the damper pin 200 and an inner circumferential surface of the damper slot 195 due to the vibration of the first and second turbine blades 184 and 184′ so that the vibration energy of the first and second turbine blades 184 and 184′ is absorbed by the friction.

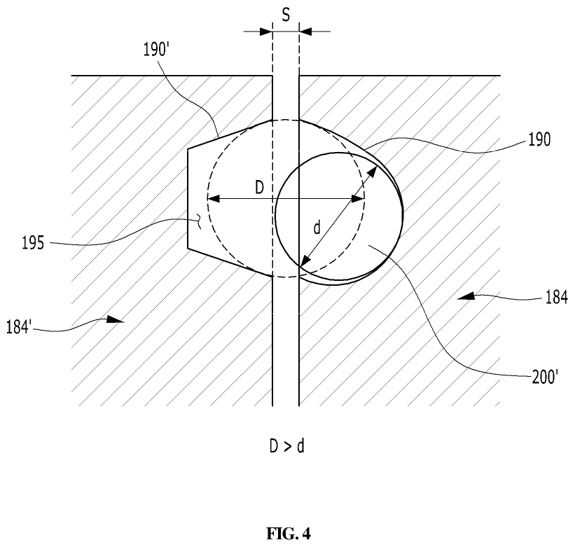

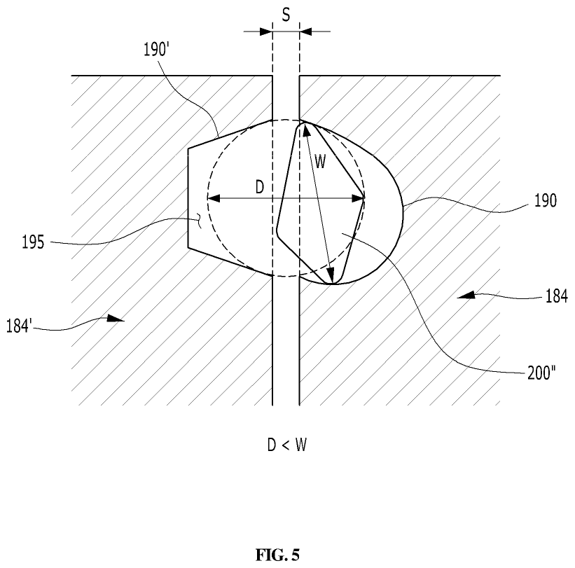

FIGS. 4 and 5 illustrate damping devices according to one or more exemplary embodiments in sectional views taken along a section perpendicular to the axial direction AX. Here, FIG. 4 illustrates an exemplary embodiment in which a cylindrical damper pin 200′ is applied and FIG. 5 illustrates an exemplary embodiment in which a polygonal damper pin 200″ is applied, whereas the damper slot 195 has the same shape in both exemplary embodiments.

In the geometry of the damper slot 195 and the damper pin 200, the damper pin 200 closely fitted in the first slot 190 protrudes out of an open inlet of the first slot 190. That is, the first slot 190 is formed to have a shallow depth that does not accommodate the entire width of the damper pin 200. A height of the damper pin 200 protruding from the open inlet of the first slot 190 has a restriction that the height should be smaller than a gap distance S between the adjacent first and second turbine blades 184 and 184′.

As described above, with respect to the sealing performance, it is more advantageous that the space of the damper slot 195 (i.e., proportional to the depth of the cross-sectional surface) has a smaller size. In a related art damping structure, the first slot is formed to be deep enough to accommodate the entire damper pin therein so that the damper pin does not protrude out of the open inlet of the first slot. This increases the dead space, which is disadvantageous in terms of the sealing performance of the turbine blade. In contrast, according to one or more exemplary embodiments, because the first slot 190 is formed to have a shallow depth such that the damper pin 200 protrudes out of the open inlet of the first slot 190, the sealing performance is improved over the related art structure.

Here, the height of the damper pin 200 protruding out of the open inlet of the first slot 190 is smaller than the gap distance S between the adjacent first and second turbine blades 184 and 184′. This is achieved for ensuring easy assembly. Thus, even when the second turbine blade 184′ is mounted onto the turbine rotor disk 180 in the axial direction AX by coupling the root part 188 to the turbine rotor disk 180 after the damper pin 200 is first placed in the first slot 190 of the first turbine blade 184, the protruded damper pin 200 does not interfere with the assembly of the second turbine blade 184′. When the second turbine blade 184′ is assembled, the damper pin 200 is temporarily attached in the first slot 190, and when the gas turbine rotates, the attachment state is released due to a vibration and/or a centrifugal force so that the damper pin 200 is moved into the damper slot 195.

Referring to FIG. 4, a cylindrical damper pin 200′ is applied as a damper pin 200. The diameter d of the cylindrical damper pin 200′ is larger than the depth of the first slot 190 so that a portion of the cylindrical damper pin 200′ protrudes out of the open inlet of the first slot 190. The protruded height of the cylindrical damper pin 200′ is smaller than the gap distance S between the first and second turbine blades 184 and 184′.

When the damper slot 195 is viewed in a section perpendicular to the axial direction AX as illustrated in FIG. 4, the diameter d of the cylindrical damper pin 200′ is smaller than a diameter D of a circle inscribed in a receiving space formed by the damper slot 195. In other words, the cylindrical damper pin 200′ is free to rotate as well as move within the damper slot 195. The freely movable and rotatable state of the cylindrical damper pin 200′in the damper slot 195 prevents the cylindrical damper pin 200′ from being jammed between the first and second turbine blades 184 and 184′.

Referring to FIG. 5, a polygonal damper pin 200″ is applied as a damper pin 200. The polygonal damper pin 200″ may be a damper pin 200″ that has a polygonal or similar cross-section with several sides and edges. Similarly, when the polygonal damper pin 200″ is inserted into the first slot 190 such that at least two sides of the polygonal damper pin 200″ is inscribed in the first slot 190, the protruded height of the polygonal damper pin 200″ is smaller than the gap distance S between the first and second turbine blades 184 and 184′.

Compared to the cylindrical damper pin 200′, the polygonal damper pin 200″ has a much larger contact area with the upper surface of the damper slot 195, so that the effect of dissipating the vibration energy due to the friction action is much better. On the other hand, the polygonal damper pin 200″ has higher jamming risk than the cylindrical damper pin 200′, because of the shape with several sides and edges.

According to the exemplary embodiment, in order to reduce the jamming risk of the polygonal damper pin 200″, the maximum width W of the polygonal damper pin 200″ is formed to be larger than the diameter D of a circle inscribed in the receiving space defined by the damper slot 195 when viewed in a section perpendicular to the axial direction AX. The maximum width W of the polygonal damper pin 200″ may be the length of the longest diagonal of the lines connecting corners of the polygonal damper pin 200″, i.e., the thickest thickness of the polygonal damper pin 200″.

Because the maximum width W of the polygonal damper pin 200″ is greater than the diameter D of the inscribed circle of the receiving space of the damper slot 195, the polygonal damper pin 200″ is not free to rotate in the damper slot 195 and thus is brought into close contact with the upper surface of the damper slot 195 by a centrifugal force within a very small rotational range that allows the polygonal damper pin 200″ initially disposed in the first slot 190 to slightly move into the damper slot 195. In this way, the rotation and posture change of the polygonal damper pin 200″ is restricted, so that the jamming risk is greatly reduced.

Each of the upper surfaces of the first slot 190 and the second slot 190′, with which the damper pin 200 is brought into contact by centrifugal force, may form an inclined surface inclined toward the direction of centrifugal force. The upper surface of the damper slot 195 is recessed in a direction to which the centrifugal force is applied, so that a stable contact of the damper pin 200 is achieved.

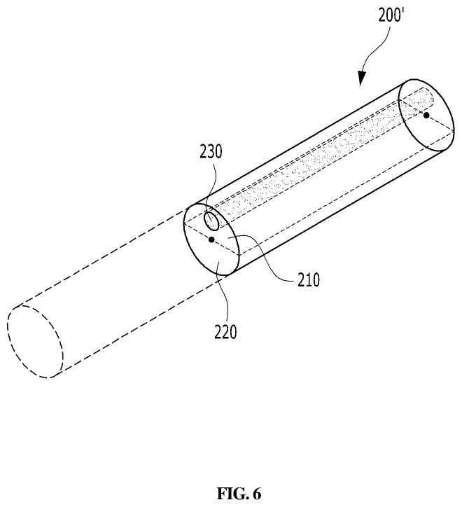

On the other hand, because the cylindrical damper pin 200′ is shaped to be freely rotatable, the vibration energy dissipation effect is deteriorated. That is, part of the vibration energy is converted not into the friction action, but into the rotational motion of the cylindrical damper pin 200′, so that sufficient vibration energy dissipation cannot be achieved. The exemplary embodiment provides a solution of the disadvantages of the cylindrical damper pin 200′, and the configurations thereof are illustrated in FIGS. 6 to 8C.

FIG. 6 is a view illustrating a cylindrical damper pin according to an exemplary embodiment. Referring to FIG. 6, the cylindrical damper pin 200′ is characterized in which when a circular section of the cylindrical damper pin 200′ perpendicular to the longitudinal direction is divided into first and second semicircular areas 210 and 220 based on the diameter as a reference line, the specific gravity of the first semicircular area 210 is lower than that of the second semicircular 220 so that the center of gravity of the cylindrical damper pin 200′is eccentric to the second semicircular area 220.

In order to eliminate the loss of friction area and reduce the jamming risk, the cylindrical damper pin 200′ may have a uniform circular cross section over the entire length of the cylindrical damper pin 200′. Thus, the exemplary embodiment provides an eccentric structure in the center of gravity through reconfiguration of the internal structure of the cylindrical damper pin 200′.

To this end, the first semicircular area 210 is provided with a low specific gravity region 230 having a density lower than that of the material of the cylindrical damper pin 200′. In other words, by forming a low specific gravity region 230 having a low density (i.e., specific gravity) in at least a part of the first semicircular area 210, the whole specific gravity of the first semicircular area 210 is made lower than that of the second semicircular area 220 so that the center of gravity of the cylindrical damper pin 200′ as a whole moves toward the second semicircular area 220 on the circular cross section. Therefore, the center of the circular section and the center of gravity of the cylindrical damper pin 200′ do not coincide with each other, and thus the center of gravity is eccentric to the second semicircular area 220.

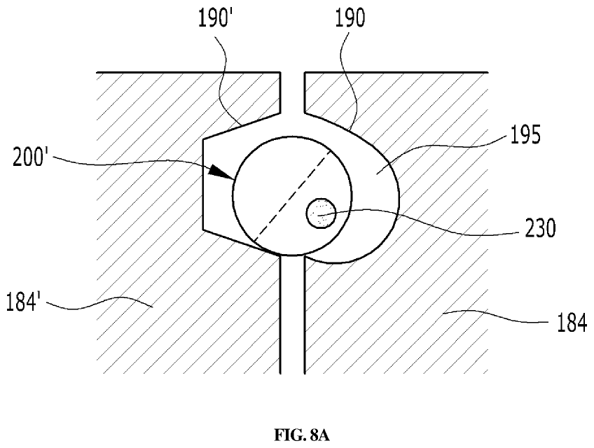

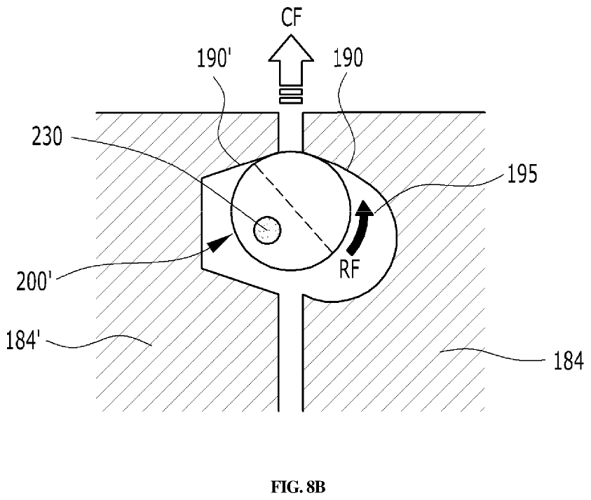

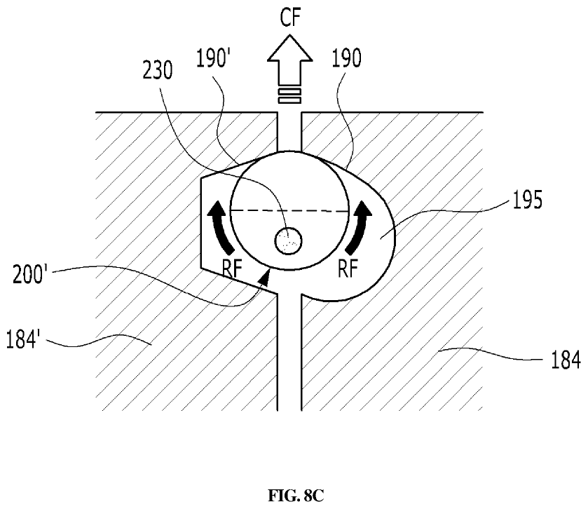

FIGS. 8A, 8B, and 8C are views illustrating a state in which the cylindrical damper pin 200′ according to the exemplary embodiment does not rotate in the damper slot 195 during operation of the gas turbine but maintains a constant position.

FIG. 8A illustrates a state in which the gas turbine is not operated, and the cylindrical damper pin 200′ is laid on the bottom surface of the damper slot 195 as an arbitrary posture. In this state, if the gas turbine operates to rotate the turbine blade 184 at a predetermined speed or more, as illustrated in FIG. 8B, the cylindrical damper pin 200′ is brought into close contact with the concave upper surface of the damper slot 195 due to the centrifugal force CF. In the state of FIG. 8B, the cylindrical damper pin 200′ undergoes a strong friction with the surface of the damper slot 195 while being subjected to the centrifugal force CF, thereby dissipating vibration energy.

The magnitude of the centrifugal force CF is proportional to the weight of an object. Because the cylindrical damper pin 200′ has a larger specific gravity in the second semicircular area 220 than in the first semicircular area 210, the centrifugal force CF applied to the second semicircular area 220 is relatively larger in magnitude than that applied to the first semicircular area 210. Accordingly, the cylindrical damper pin 200′ is subjected to a force with which the second semicircular area 220 having a larger specific gravity is positioned outside the centrifugal force CF (i.e., radially outward, upward in the drawing). Because the vibration is transmitted to the cylindrical damper pin 200′, the cylindrical damper pin 200′ receives the centrifugal force CF while being vibrated, so that the cylindrical damper pin 200′ slightly rotates such that the second semicircular area 220 is positioned radially outwards. Further, as illustrated in FIG. 8C, the cylindrical damper pin 200′ is positioned in the direction in which the center of gravity of the cylindrical damper pin 200′ and the direction of the centrifugal force CF coincide with each other while the second semicircular area 220 is located radially outwards.

In the state of FIG. 8C, the cylindrical damper pin 200′ is subjected to vibration, and thus it is rotated left and right little by little. If the cylindrical damper pin 200′ is displaced from the direction in which the center of gravity of the cylindrical damper pin 200′ coincides with the direction of the centrifugal force CF, because the centrifugal force CF acts in a direction perpendicular to the rotary axis, a component force that acts to return to the state of FIG. 8C in proportional to the degree at which the center of gravity is displaced. In other words, during the operation of the gas turbine, the state of FIG. 8C is set to the neutral state, and the centrifugal force CF applied to the cylindrical damper pin 200′ in which the center of gravity is eccentrically applied acts as a restoring force RF to return to the neutral state.

Accordingly, in accordance with one or more exemplary embodiments, the disadvantageous feature of the cylindrical damper pin 200′ being free to rotate may be changed to the advantageous feature of the cylindrical damper pin 200′ easily returning to a predetermined neutral state during operation of the gas turbine. Thus, the cylindrical damper pin 200′ does not frequently rotate during the operation of the gas turbine, and the dissipation effect of vibration energy due to friction increases.

The low specific gravity region 230 may be formed in the first semicircular area 210 by forming a hollow hole in the longitudinal direction through the first semicircular area 210 or by filling a predefined hollow hole with a material having a lower density than that of the cylindrical damper pin 200′. Here, if the material to be filled in the hollow hole is appropriately selected, another function may be added to the cylindrical damper pin 200′. For example, the thermal conduction performance can be improved by filling the hollow hole with a light carbon material, and the high thermally-conductive cylindrical damper pin 200′ may help cool the turbine blade 184.

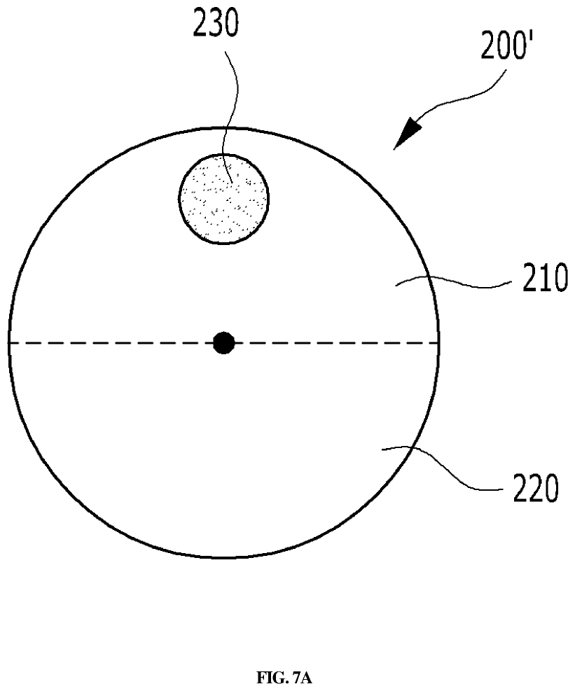

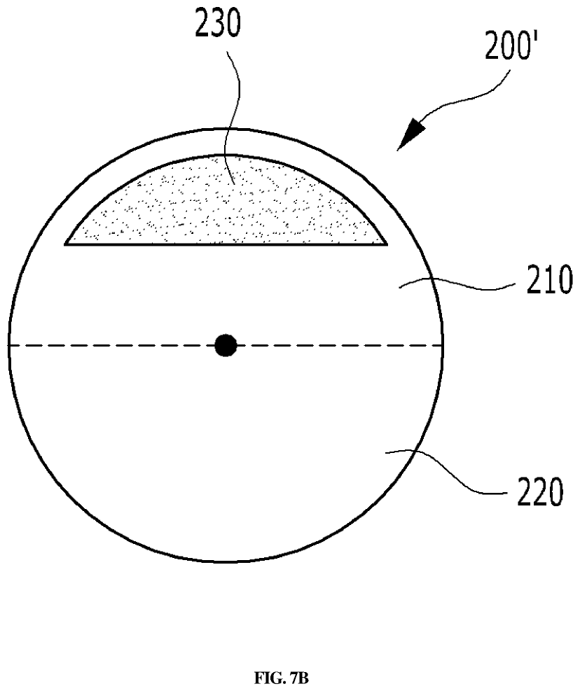

FIGS. 7A and 7B are sectional views of the cylindrical damper pin 200′ according to one or more exemplary embodiments, taken in a direction perpendicular to the longitudinal direction. The low specific gravity region 230 may be formed in a shape of a circular section as illustrated in FIG. 7A, or a shape extended widely in a hill shape as illustrated in FIG. 7B. However, it is preferable that the low specific gravity region 230 is formed closer to the circumferential surface of the cylindrical damper pin 200′ in the first semicircular area 210. That is, the low specific gravity region 230 having a circular cross section may be disposed closer to the circumferential surface, or the low specific gravity region 230 having a hill shape is disposed widely towards the circumferential surface. This is because the centrifugal force acts relatively stronger on the outer side of the cylindrical damper pin 200′ (i.e., the magnitude of the centrifugal force is proportional to the distance from the rotary axis), it is advantageous that the circumferential surface side of the first semicircular area 210 is lighter than the other portion as it enhances the effect of the centrifugal force acting on the circumferential surface side of the second semicircular region 220.

While exemplary embodiments have been described with reference to the accompanying drawings, it will be apparent to those skilled in the art that various modifications in form and details can be made therein without departing from the spirit and scope as set forth in the appended claims. Therefore, the description of the exemplary embodiments should be construed in a descriptive sense and not to limit the scope of the claims, and many alternatives, modifications, and variations will be apparent to those skilled in the art.

What is claimed is:

1. A damping device for a turbine blade assembly, the damping device comprising:
a damper slot formed by first and second slots being axially opposite to each other under respective platforms of adjacent first and second turbine blades of a plurality of turbine blades radially disposed along circumferential surfaces of turbine rotor disks; and
a damper pin disposed in the damper slot,
wherein the damper pin disposed in the damper slot partially protrudes out of an open inlet of the first slot such that a height of the damper pin protruding out of the open inlet of the first slot is smaller than a gap distance between the first and second turbine blades.

2. The damping device according to claim 1, wherein the damper pin is a cylindrical damper pin, and
wherein a diameter of the cylindrical damper pin is larger than a depth of the first slot.

3. The damping device according to claim 2, wherein when the damper slot is viewed in a section perpendicular to an axial direction of the damper slot, the diameter of the cylindrical damper pin is smaller than a diameter of a circle inscribed in a receiving space of the damper slot.

4. The damping device according to claim 1, wherein the damper pin is a polygonal damper pin, and
wherein when at least two sides of the polygonal damper pin are in close contact with an inside of the first slot, a height of the polygonal damper pin protruding out of the open inlet of the first slot is smaller than the gap distance between the first and second turbine blades.

5. The damping device according to claim 4, wherein when the damper slot is viewed in a section perpendicular to an axial direction, a maximum width of the polygonal damper pin is larger than a diameter of a circle inscribed in a receiving space of the damper slot.

6. The damping device according to claim 1, wherein each upper surfaces of the first slot and the second slot forms an inclined surface inclined toward a direction of centrifugal force.

7. The damping device according to claim 3, wherein when a circular cross section of the cylindrical damper pin, perpendicular to a longitudinal direction of the cylindrical damper pin, is divided into a first semicircular area and a second semicircular area based on a diameter as a reference line, specific gravity of the first semicircular area is lower than that of the second semicircular area so that a center of gravity of the damper pin is eccentric to the second semicircular area.

8. The damping device according to claim 7, wherein the first semicircular area includes a low specific gravity region having a density lower than that of a material of the damper pin.

9. The damping device according to claim 8, wherein the low specific gravity region is filled with a material having a lower density than the material of the damper pin or the low specific gravity region is formed as a hollow portion.

10. The damping device according to claim 8, wherein the low specific gravity region is formed closer to a circumferential surface of the damper pin in the first semicircular area.

11. A turbine blade assembly comprising:
a plurality of turbine rotor disks;
a plurality of turbine blades each radially disposed along a circumferential surface of the turbine rotor disk; and
a damper device comprising a damper slot formed by first and second slots being axially opposite to each other under respective platforms of adjacent first and second turbine blades of a plurality of turbine blades radially disposed along circumferential surfaces of the turbine rotor disks, and a damper pin disposed in the damper slot,
wherein the damper pin disposed in the damper slot partially protrudes out of an open inlet of the first slot such that a height of the damper pin protruding out of the open inlet of the first slot is smaller than a gap distance between the first and second turbine blades.

12. The turbine blade assembly according to claim 11, wherein the damper pin is a cylindrical damper pin, and
wherein a diameter of the cylindrical damper pin is larger than a depth of the first slot.

13. The turbine blade assembly according to claim 12, wherein when the damper slot is viewed in a section perpendicular to an axial direction of the damper slot, the diameter of the cylindrical damper pin is smaller than a diameter of a circle inscribed in a receiving space of the damper slot.

14. The turbine blade assembly according to claim 11, wherein the damper pin is a polygonal damper pin, and
wherein when at least two sides of the polygonal damper pin are in close contact with an inside of the first slot, a height of the polygonal damper pin protruding out of the open inlet of the first slot is smaller than the gap distance between the first and second turbine blades.

15. The turbine blade assembly according to claim 14, wherein when the damper slot is viewed in a section perpendicular to an axial direction, a maximum width of the polygonal damper pin is larger than a diameter of a circle inscribed in a receiving space of the damper slot.

16. The turbine blade assembly according to claim 11, wherein each upper surfaces of the first slot and the second slot forms an inclined surface inclined toward a direction of centrifugal force.

17. The turbine blade assembly according to claim 13, wherein when a circular cross section of the cylindrical damper pin, perpendicular to a longitudinal direction of the cylindrical damper pin, is divided into a first semicircular area and a second semicircular area based on a diameter as a reference line, specific gravity of the first semicircular area is lower than that of the second semicircular area so that a center of gravity of the damper pin is eccentric to the second semicircular area.

18. The turbine blade assembly according to claim 17, wherein the first semicircular area includes a low specific gravity region having a density lower than that of a material of the damper pin.

19. The turbine blade assembly according to claim 18, wherein the low specific gravity region is filled with a material having a lower density than the material of the damper pin or the low specific gravity region is formed as a hollow portion.

20. The turbine blade assembly according to claim 18, wherein the low specific gravity region is formed closer to a circumferential surface of the damper pin in the first semicircular area.
